(19) United States
(12) Patent Application Publication
(10) Pub. No.: US 2026/0287489 A1
(43) Pub. Date: Sep. 24, 2026

(54) THE DIFFUSIVITY MEASUREMENT ALGORITHM OF A TWO-DIMENSIONAL HEAT DISSIPATION DEVICE

(71) Applicant: Hong-Long CHEN, New Taipei City (TW)

(72) Inventor: Hong-Long CHEN, New Taipei City (TW)

(21) Appl. No.: 19/354,226

(22) Filed: Oct. 9, 2025

(30) Foreign Application Priority Data
Jan. 3, 2025 (TW) 114100371

(51) Int. Cl. G01N 13/00

(52) U.S. Cl. CPC G01N 13/00; G01N 2013/003

(57) ABSTRACT

The present invention is related to the diffusivity measurement algorithm of a two-dimensional heat dissipation device. The one-dimensional algorithm can only be applied to heat pipes. The two-dimensional heat diffusion rate algorithm and measurement method are developed specifically for vapor chambers, 3DVC and other products. On the bottom surface of the vapor chamber of a heat dissipation module, select two measuring points from the edge of the heat source to the outside of the base plate, and then measure the temperature of the two measuring points separately, and through equation (1), the heat diffusion rate or a value of the vapor chamber can be obtained. Equation (1) is the analytical solution obtained after solving the two-dimensional energy equation. By applying this algorithm, the test instrument can measure two-dimensional products with two-dimensional area diffusion physical phenomena such as vapor chamber, 3DVC, and cold plate.

This application claims the priority benefit of Taiwan patent application number 114100371, filed on Jan. 3, 2025.

### BACKGROUND OF THE INVENTION

### 1. Field of the Invention

All material has fixed diffusivity value for heat transfer calculations. However, vapor chamber which is not a material but widely applied in electronic cooling industry. VC (Vapor Chamber) is a two phase flow device which has no fixed diffusivity for designed reference. The present invention provides a two dimensional heat diffusivity measurement algorithm that can theoretically define the heat diffusivity of a VC, and complex thermal module or even a liquid cooling cold plate for design reference. The present invention is based on the theory of energy balance equation as the physical model and the mathematical model. After solving the energy equation, diffusivity α is theoretical defined from this theoretical basis. This new method will set a new milestone for the industry to apply the turbo boost functionality built inside modern computer chips.

### 2. Description of the Related Art

A thermal module is a device widely used for dissipating heat from chips used in computers (such as CPUs or GPUs). Conventional thermal modules typically comprise a metal base plate (made of aluminum or copper) or a vapor chamber (VC), on top of which are arranged multiple heat-dissipating fins. The base plate is attached to a heat source, enabling heat to spread outwards from the center to the edge of plate, and then the heat is conducted to the multiple fins on the plate, thereby achieving the desired heat dissipation effect.

In modern-generation chips are built with turbo boost (or overclocking) functionality to obtain extra computing power. In order to apply this functionality, thermal diffusivity is a key design parameter. Therefore, how to theoretically define the thermal diffusivity of a vapor chamber has become a critical issue in thermal management industry.

Traditionally, thermal module performance measurement is to measure thermal resistance in steady state, and such values are not time-dependent. In contrast, thermal diffusivity of a thermal module is defined as the speed at which how fast heat is transferred, providing a concrete and practical value to design thermal module suitable for turbo boost function for new generation chips. By accurately obtaining the thermal diffusivity coefficient, engineers can optimize the overclocking performance of computers.

### SUMMARY OF THE INVENTION

The main object of the present invention is to provide a method for measuring the transient thermal diffusivity of a two-dimensional thermal module, which can be VC/thermal module/cold plate etc.

Another object of the present invention is from this theoretically defined transient thermal diffusivity of a thermal module, engineers are able to optimize computer chip's turbo boost function to enhance the computing power.

In order to achieve the above objects, the present invention proposes a method for measuring the transient thermal diffusivity of a two-dimensional vapor chamber (VC) thermal module. To simplify the two-dimensional mathematical equations, cylindrical coordinates are used by substituting a position variable R (radius) with the two variables X and Y in Cartesian coordinates. The conversion relationship between the two coordinate systems is R=(X²+Y²)^{1/2}. After solving the equations in cylindrical coordinates, the result is transformed back into Cartesian coordinates using R=(X²+Y²)^{1/2}. The measurement method comprises of the following steps A) through D):
A) Determining a first measurement point (the edge of the heat source on plate) and a second measurement point (the outermost edge of the base plate): The surface of the thermal module that contacts the heat source is defined as the heat-conducting surface. The center of the area on this surface where it contacts the heat source is defined as the heat center point. A circular or rectangular area is defined on the heat-conducting surface with this heat center point as its center.
B) Measuring temperatures: The thermal module is attached to the heat source. Under the condition where the heat source generates heat steadily, the temperature at the first measurement point and the second measurement point is recorded over time, until the thermal module reaches a steady-state heat dissipation condition.
C) Substituting into calculation formulas: The temperatures and distance between the first and second measurement points are substituted into the following formulas (2) and (3) to calculate the M value. For the relevant positions of R1/R2, please refer to FIG. 1.

$$θ ( {R}_{1} , ∞ ) = \frac{{I}_{1} ( M ) {K}_{o} ( {MR}_{1} ) + {I}_{o} ( {MR}_{1} ) {K}_{1} ( M )}{M ( {I}_{1} ( M ) {K}_{1} ( aM ) - {I}_{1} ( aM ) {K}_{1} ( M ) )} \qquad ( 2 )$$

$$θ ( {R}_{2} , ∞ ) = \frac{{I}_{1} ( M ) {K}_{o} ( {MR}_{2} ) + {I}_{o} ( {MR}_{2} ) {K}_{1} ( M )}{M ( {I}_{1} ( M ) {K}_{1} ( aM ) - {I}_{1} ( aM ) {K}_{1} ( M ) )} \qquad ( 3 )$$

$$in which$$

$$θ ( R , τ ) = \frac{T ( t ) - {T}_{∞}}{( q / k ) {r}_{a}} ,$$

$$M = \sqrt{\frac{h}{{kt}_{b}}} {r}_{a} ,$$

$$R = \frac{r}{{r}_{a}} ,$$

$$τ \frac{α t}{{r}_{a}^{2}} ,$$

$$α = \frac{{r}_{a}^{2} τ}{t} ;$$

in which: I₀/I₁/K₀/K₁ is the Bessel function in mathematics, M is the ratio of thermal conduction to thermal convection intensity, h is the convection heat transfer coefficient, K is the thermal conductivity coefficient, rₐ is the characteristic radius (the distance from the center of the base plate to R₂), T is the temperature, t is the time, R is the dimensionless position variable, R₁ is the dimensionless distance between the first measuring point and the center of the hot spot, and R₂ is the dimensionless distance between the second measuring point and the center of the hot spot. From the above equations (2) and (3), M value can be obtained.
D) Results: Substituting the temperature T₁ at a certain transient time t₁ obtained in step C) from the distance R₁ between M and the first measuring point into equation (1), the value of the heat diffusion coefficient or diffusivity α can be obtained. The value of the heat diffusion coefficient α is used to represent the transient heat diffusivity of the heat dissipation module.

$$θ ( R , τ ) = \frac{{I}_{1} ( M ) {K}_{0} ( MR ) + {I}_{0} ( MR ) {K}_{1} ( M )}{M ( {I}_{1} ( M ) {K}_{1} ( aM ) - {I}_{1} ( M ) {K}_{1} ( aM ) )} + {\sum }_{n = 1}^{∞} {A}_{n} [ {J}_{0} ( {λ}_{n} R ) {Y}_{1} ( {λ}_{n} a ) - {J}_{1} ( {λ}_{n} a ) {Y}_{0} ( {λ}_{n} R ) ] {e}^{- ( {M}^{2} + {λ}_{n}^{2} ) τ} \qquad ( 1 )$$

The above equation (1) can be replaced by R=(X²+Y²)^{1/2} to change to the rectangular coordinate equation as shown in equation (6):

$$θ ( X , Y , τ ) = \frac{{I}_{1} ( M ) {K}_{0} ( {M ( {X}^{2} + {Y}^{2} )}^{1 / 2} ) + {I}_{0} ( {M ( {X}^{2} + {Y}^{2} )}^{1 / 2} ) {K}_{1} ( M )}{M ( {I}_{1} ( M ) {K}_{0} ( {( {X}_{1}^{2} + {Y}_{1}^{2} )}^{1 / 2} M ) - {I}_{1} ( M ) {K}_{1} ( {( {X}_{1}^{2} + {Y}_{1}^{2} )}^{1 / 2} M ) )} + {\sum }_{n = 1}^{∞} {A}_{n} [ {J}_{0} ( {{λ}_{n} ( {X}^{2} + {Y}^{2} )}^{1 / 2} ) {Y}_{1} ( {{λ}_{n} ( {X}_{1}^{2} + {Y}_{1}^{2} )}^{1 / 2} ) - {J}_{1} ( {λ}_{n} {( {X}_{1}^{2} + {Y}_{1}^{2} )}^{1 / 2} ) {Y}_{0} ( {{λ}_{n} ( {X}^{2} + {Y}^{2} )}^{1 / 2} ) ] {e}^{- ( {M}^{2} + {λ}_{n}^{2} ) τ} \qquad ( 6 )$$

in which, X/Y is the dimensionless position of the base plate, and X₁/Y₁ is the dimensionless position of the heat source.

Thus, the present invention is trying to use the theory of energy balance equation as the physical model and the mathematical model. After solving the 2nd derivative partial differential equation by mathematical technique, equation (1) is derived as the closed form solution. Since diffusivity α is existing inside equation, by temperature rising curve data to obtain M value. Finally, diffusivity α is theoretical defined. Without this value, the new chips with turbo boost function cannot be fully applied in the industry.

### BRIEF DESCRIPTION OF THE DRAWINGS

FIG. 1 is a flow chart (right side) showing the size-related positions (left side) of an embodiment of the present invention.

FIG. 2 is a schematic diagram of the combination of the vapor chamber and the heat dissipation module according to an embodiment of the present invention.

FIG. 3 is a plane curve diagram of the temperature rise curve T vs. time of the vapor chamber drawn by the algorithm of the present invention.

FIGS. 4A-4D are three-dimensional diagrams of the temperature distribution of the vapor chamber at time τ=1/2/3/4 drawn by the algorithm of the present invention.

### DETAILED DESCRIPTION OF THE PREFERRED EMBODIMENT

In order to explain the technical features of the present invention in detail, the following preferred embodiment is described with reference to the accompanying drawings, wherein:

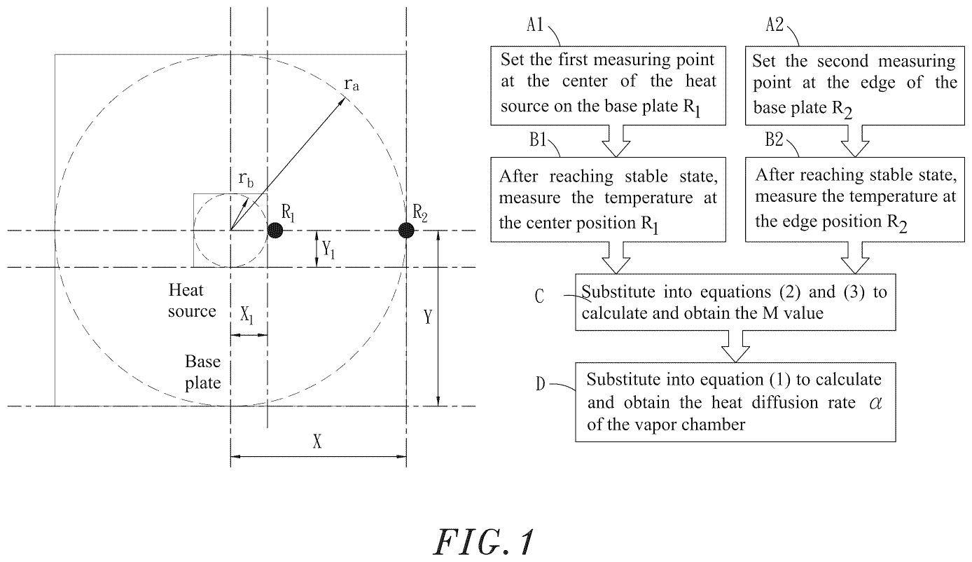

As shown in FIG. 1, a method for measuring the transient heat diffusivity of a VC or thermal module according to a preferred embodiment of the present invention is mainly performed by the following steps:
A) Determining the positions of a first measuring point R₁ (A1) and a second measuring point R₂ (A2): The physical phenomenon of heat diffusion is that heat energy is transferred from the heat source located in the center of the base plate (such as the central processing unit (CPU) or GPU) to the vapor chamber spreading outwards in the form of annular isotherms. Therefore, it is reasonable to use cylindrical coordinates to obtain the mathematical analytical solution of the energy equation. However, the chip heat source and the contacting base plate are both rectangular. For the accuracy of calculation, the first measuring point R₁ is attached to the side of the heat source, and the second measuring point R₂ must be located at four points on the outside of the vapor chamber (or thermal module) at the same radius of 0°/90°/180°/270°. FIG. 1 shows the 0° point.
B) Measuring temperature: Place the heat dissipation module on the heat source, and measure the temperature changes of the first measuring point R₁ (B1) and the second measuring point R₂ (B2) over time when the heat source is stably heating. When the temperature rising curve of the heat dissipation module no longer changes over time, it enters a steady state.
C) Substituting into the formula: Substitute the temperature and distance of the first measuring point R₁ (B1) and the second measuring point R₂ (B2) into the following equations (2) and (3) to calculate and obtain the M value (the ratio of thermal convection coefficient to conductivity) of the VC (or heat dissipation module):

$$θ ( {R}_{1} , ∞ ) = \frac{{I}_{1} ( M ) {K}_{o} ( {MR}_{1} ) + {I}_{o} ( {MR}_{1} ) {K}_{1} ( M )}{M ( {I}_{1} ( M ) {K}_{1} ( aM ) - {I}_{1} ( aM ) {K}_{1} ( M ) )} \qquad ( 2 )$$

$$θ ( {R}_{2} , ∞ ) = \frac{{I}_{1} ( M ) {K}_{o} ( {MR}_{2} ) + {I}_{o} ( {MR}_{2} ) {K}_{1} ( M )}{M ( {I}_{1} ( M ) {K}_{1} ( aM ) - {I}_{1} ( aM ) {K}_{1} ( M ) )} \qquad ( 3 )$$

After obtaining the M value, substitute it into the main equation (1), the temperature distribution curve can be correctly defined with time t and τ still unknown to solve.

$$θ ( R , τ ) = \frac{{I}_{1} ( M ) {K}_{0} ( MR ) + {I}_{0} ( MR ) {K}_{1} ( M )}{M ( {I}_{1} ( M ) {K}_{1} ( aM ) - {I}_{1} ( M ) {K}_{1} ( aM ) )} + {\sum }_{n = 1}^{∞} {A}_{n} [ {J}_{0} ( {λ}_{n} R ) {Y}_{1} ( {λ}_{n} a ) - {J}_{1} ( {λ}_{n} a ) {Y}_{0} ( {λ}_{n} R ) ] {e}^{- ( {M}^{2} + {λ}_{n}^{2} ) τ} \qquad ( 1 )$$

$${A}_{n} = ( 2 πλ ( 2 ( {I}_{1} ( a M ) {K}_{1} ( M ) - {I}_{1} ( M ) {K}_{1} ( a M ) ) {M}^{2} + {πλ}^{2} ( {J}_{1} ( λ ) {Y}_{1} ( a λ ) - {J}_{1} ( a λ ) {Y}_{1} ( λ ) ) ) ) / ( {M}^{2} ( {M}^{2} + {λ}^{2} ) ( {I}_{1} ( a M ) {K}_{1} ( M ) - {I}_{1} ( M ) {K}_{1} ( a M ) ) ( {π}^{2} {λ}^{2} ( ( {{Y}_{0} ( λ )}^{2} + {{Y}_{1} ( λ )}^{2} ) {{J}_{1} ( a λ )}^{2} + {{J}_{1} ( λ )}^{2} ) {{Y}_{1} ( a λ )}^{2} ) - 4 ) ) \qquad ( 5 )$$

$$in which$$

$$θ ( R , τ ) = \frac{T ( t ) - {T}_{∞}}{( q / k ) {r}_{a}} ,$$

$$M = \sqrt{\frac{h}{{kt}_{b}}} {r}_{a} ,$$

$$R = \frac{r}{{r}_{a}} ,$$

$$τ \frac{α t}{{r}_{a}^{2}} ,$$

$$α = \frac{{r}_{a}^{2} τ}{t} ;$$

in which: I₀/I₁/K₀/K₁ is the Bessel function in mathematics, M is the ratio of thermal conduction to thermal convection intensity, h is the convection heat transfer coefficient, K is the thermal conductivity coefficient, q is the input heat flux, rₐ is the characteristic radius, θ is the dimensionless temperature, T is the temperature (° C.), τ is the dimensionless time, t is the time (seconds), R is the dimensionless relative position (r/rₐ), λₐ is the eigenvalue, α is the ratio of the heat source radius to the base plate radius, and α is the final thermal diffusivity to be obtained. The M value is the ratio of the thermal convection intensity to thermal conductivity measured on the instrument. After substituting it into the above equation (1), the correct temperature rise equation can be obtained.
D) Results: Substituting the correct temperature rise equation obtained in step C) into equation (1) with the temperature T₁ of the first measuring point R₁ at a certain transient moment t₁, the value of the heat diffusivity coefficient α of the vapor chamber (or thermal module) can be obtained.

The above describes the various steps of the measuring method of the present invention.

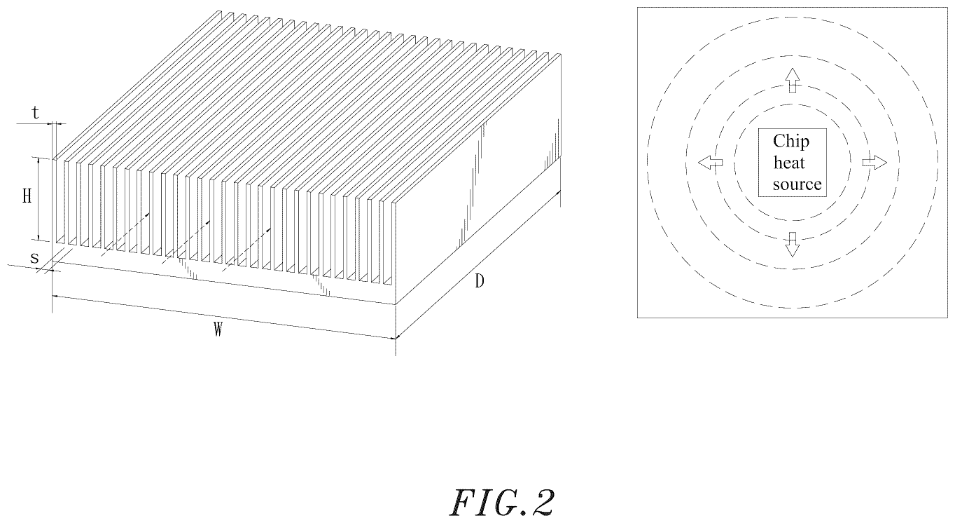

It is difficult to use mathematical methods to obtain a correct analytical solution as an algorithm for calculating the heat diffusivity coefficient. If you want to measure the heat diffusivity on a test instrument, you must have the correct analytical solution as the core program. Therefore, how to derive the analytical solution of the two-dimensional transient equation is the biggest challenge of the present invention. As shown in FIG. 2, the right side is a commonly used combination of vapor chamber+fin module, and the right side is a front view of the base plate. Through the observation of thermal transfer phenomena, the energy of the CPU chip diffuses from the center to the outside in the form of an annular isotherm. Therefore, we can first convert the two variables X/Y of the energy equation in rectangular coordinates into cylindrical coordinates through R=(X²+Y²)^{1/2}, reducing the two variables to one variable. The final analytical solution is presented as a combination of Bessel function and Fourier infinite series. According to calculations, as long as the fifth term of the Fourier series is reached, the accuracy can reach 99.9%. That is, the accuracy of this solution can represent the correct analytical solution. Each Fourier series must have a corresponding eigenvalue λₙ and Eigenterm Aₙ. λₙ can be solved recursively from equation (4), and Aₙ is shown in equation (5).

$${λ}_{n} ⇒ {λ}_{n} {J}_{1} ( a {λ}_{n} ) {Y}_{1} ( a {λ}_{n} ) - {λ}_{n} {J}_{1} ( {λ}_{n} ) {Y}_{1} ( a {λ}_{n} ) = 0 \qquad ( 4 )$$

$${A}_{n} = ( 2 πλ ( 2 ( {I}_{1} ( a M ) {K}_{1} ( M ) - {I}_{1} ( M ) {K}_{1} ( a M ) ) {M}^{2} + {πλ}^{2} ( {J}_{1} ( λ ) {Y}_{1} ( a λ ) - {J}_{1} ( a λ ) {Y}_{1} ( λ ) ) ) ) / ( {M}^{2} ( {M}^{2} + {λ}^{2} ) ( {I}_{1} ( a M ) {K}_{1} ( M ) - {I}_{1} ( M ) {K}_{1} ( a M ) ) ( {π}^{2} {λ}^{2} ( ( {{Y}_{0} ( λ )}^{2} + {{Y}_{1} ( λ )}^{2} ) {{J}_{1} ( a λ )}^{2} + {{J}_{1} ( λ )}^{2} ) {{Y}_{1} ( a λ )}^{2} ) - 4 ) ) \qquad ( 5 )$$

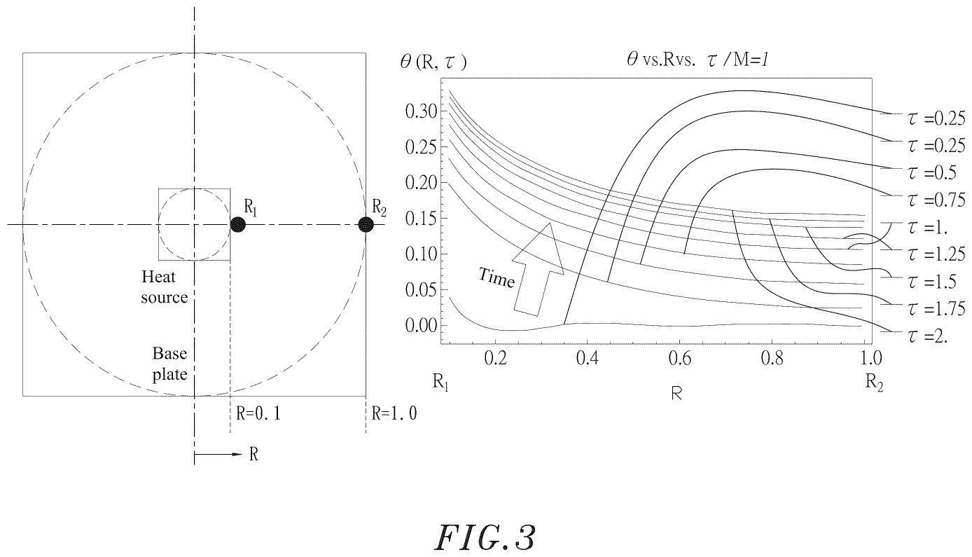

As shown on the left side of FIG. 3, the ratio of the chip radius to the base plate radius is a=0.1. At the position of R₁=0.1 and at the position of R₂=1, the time versus temperature rising curve drawn by equation (1) is shown on the right side of FIG. 3. At the beginning, the temperature rise changes dramatically. As time continues proceeding, it gradually saturates. Finally, the temperature stops changing and enters the steady-state heat transfer range.

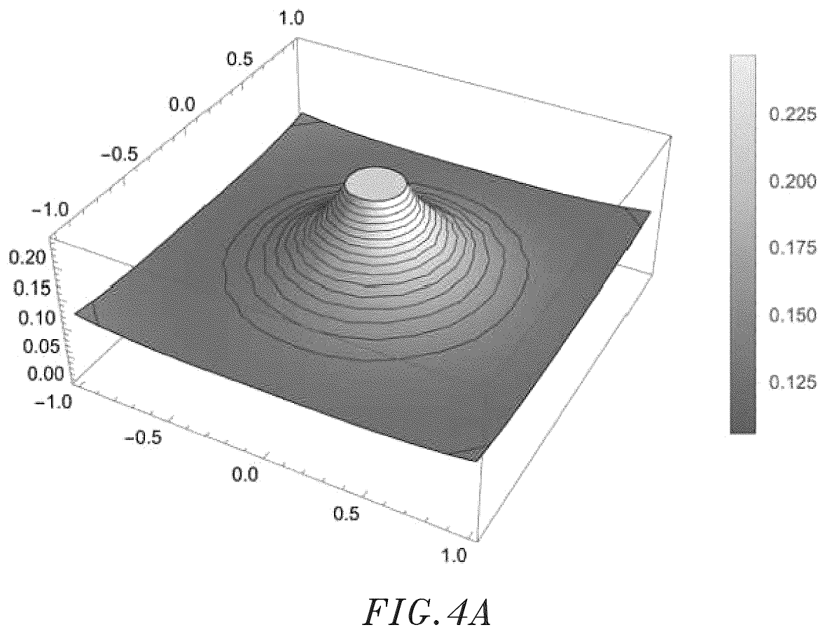

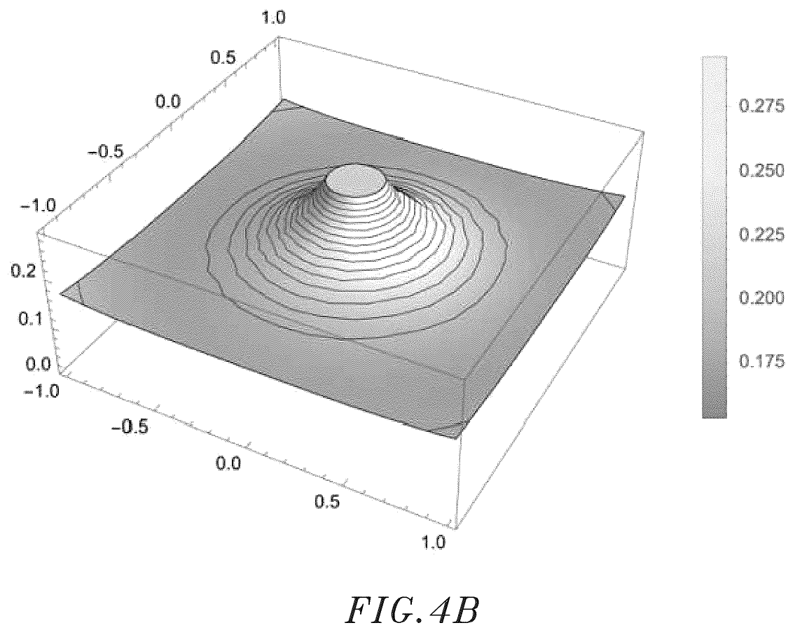

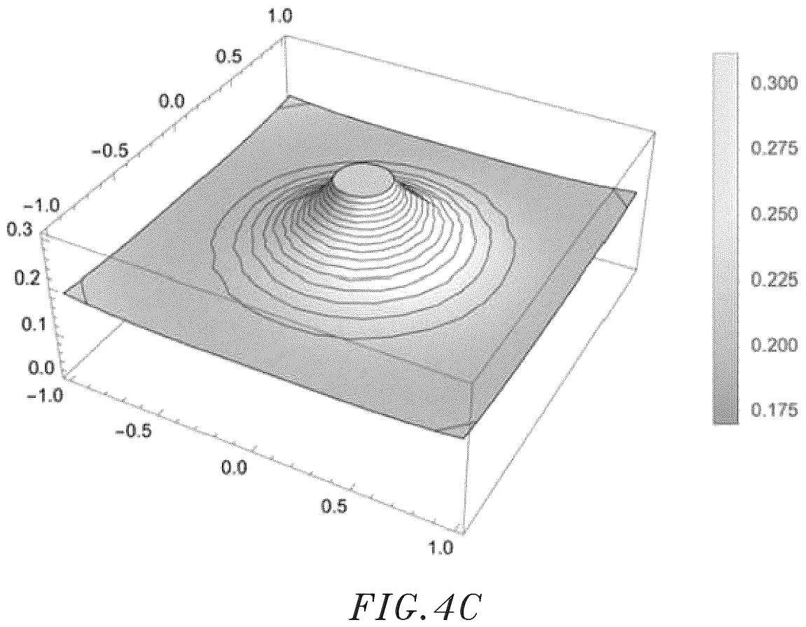

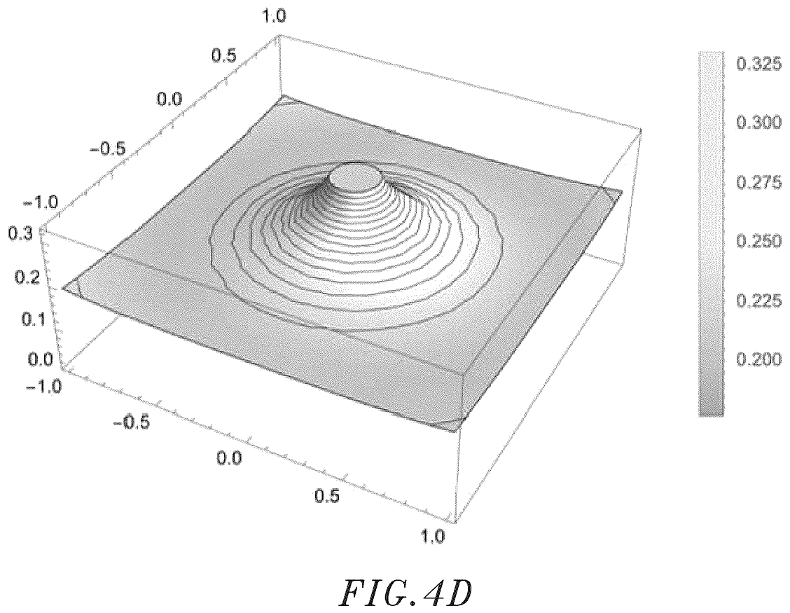

As shown in FIGS. 4A-4D, the coordinates are converted to rectangular coordinates by R=(X²+Y²)^{1/2}. FIG. 4A is the temperature distribution diagram for τ=1, the highest dimensionless temperature reaches 0.226; FIG. 4B is the temperature distribution diagram for τ=2, the highest dimensionless temperature reaches 0.275; FIG. 4C is the temperature distribution diagram for τ=3, the highest dimensionless temperature reaches 0.3; FIG. 4D is the temperature distribution diagram for τ=4, the highest dimensionless temperature reaches 0.325. At the beginning, the temperature rise changes dramatically. As time continues proceeding, it gradually saturates. Finally the temperature stops changing and enters the steady-state heat transfer range.

The above equation (1) can be replaced by R=(X²+Y²)^{1/2} to change to the rectangular coordinate equation as shown in equation (6).

$$θ ( X , Y , τ ) = \frac{{I}_{1} ( M ) {K}_{0} ( {M ( {X}^{2} + {Y}^{2} )}^{1 / 2} ) + {I}_{0} ( {M ( {X}^{2} + {Y}^{2} )}^{1 / 2} ) {K}_{1} ( M )}{M ( {I}_{1} ( M ) {K}_{0} ( {( {X}_{1}^{2} + {Y}_{1}^{2} )}^{1 / 2} M ) - {I}_{1} ( M ) {K}_{1} ( {( {X}_{1}^{2} + {Y}_{1}^{2} )}^{1 / 2} M ) )} + {\sum }_{n = 1}^{∞} {A}_{n} [ {J}_{0} ( {{λ}_{n} ( {X}^{2} + {Y}^{2} )}^{1 / 2} ) {Y}_{1} ( {{λ}_{n} ( {X}_{1}^{2} + {Y}_{1}^{2} )}^{1 / 2} ) - {J}_{1} ( {λ}_{n} {( {X}_{1}^{2} + {Y}_{1}^{2} )}^{1 / 2} ) {Y}_{0} ( {{λ}_{n} ( {X}^{2} + {Y}^{2} )}^{1 / 2} ) ] {e}^{- ( {M}^{2} + {λ}_{n}^{2} ) τ} \qquad ( 6 )$$

In summary, the present invention is based on the theory of energy balance equation as the physical model and the mathematical model. After solving the energy equation by mathematical technique, equation (1) is derived as the closed form solution. Finally, diffusivity α is theoretical defined from this theoretical basis. Without this value, the new chips with turbo boost function cannot be fully applied in the industry, and this new method will set a new milestone for the industry to apply the turbo boost functionality built inside computer chips.

What the invention claimed is:

1. A method for measuring the transient heat diffusivity of a VC/thermal module/cold plate, using equation (1) as the main core calculation program of the measuring instrument, and equations (2) and (3) for obtaining the M value in the steady-state range, comprising:
$$θ ( R , τ ) = \frac{{I}_{1} ( M ) {K}_{0} ( MR ) + {I}_{0} ( MR ) {K}_{1} ( M )}{M ( {I}_{1} ( M ) {K}_{1} ( aM ) - {I}_{1} ( M ) {K}_{1} ( aM ) )} + {\sum }_{n = 1}^{∞} {A}_{n} [ {J}_{0} ( {λ}_{n} R ) {Y}_{1} ( {λ}_{n} a ) - {J}_{1} ( {λ}_{n} a ) {Y}_{0} ( {λ}_{n} R ) ] {e}^{- ( {M}^{2} + {λ}_{n}^{2} ) τ} \qquad ( 1 )$$
$${A}_{n} = ( 2 πλ ( 2 ( {I}_{1} ( a M ) {K}_{1} ( M ) - {I}_{1} ( M ) {K}_{1} ( a M ) ) {M}^{2} + {πλ}^{2} ( {J}_{1} ( λ ) {Y}_{1} ( a λ ) - {J}_{1} ( a λ ) {Y}_{1} ( λ ) ) ) ) / ( {M}^{2} ( {M}^{2} + {λ}^{2} ) ( {I}_{1} ( a M ) {K}_{1} ( M ) - {I}_{1} ( M ) {K}_{1} ( a M ) ) ( {π}^{2} {λ}^{2} ( ( {{Y}_{0} ( λ )}^{2} + {{Y}_{1} ( λ )}^{2} ) {{J}_{1} ( a λ )}^{2} + {{J}_{1} ( λ )}^{2} ) {{Y}_{1} ( a λ )}^{2} ) - 4 ) ) \qquad ( 5 )$$
$$in which$$
$$θ ( R , τ ) = \frac{T ( t ) - {T}_{∞}}{( q / k ) {r}_{a}} ,$$
$$M = \sqrt{\frac{h}{{kt}_{b}}} {r}_{a} ,$$
$$R = \frac{r}{{r}_{a}} ,$$
$$τ \frac{α t}{{r}_{a}^{2}} ,$$
$$α = \frac{{r}_{a}^{2} τ}{t} ;$$
in which: M is the ratio of convection intensity to thermal conductivity, h is the convection heat transfer coefficient, K is the thermal conductivity coefficient, q is the input heat flux, rₐ is the characteristic radius, θ is the dimensionless temperature, T is the temperature (° C.), τ is the dimensionless time, t is the time (seconds), R is the dimensionless relative position (r/rₐ), λₙ is the Eigenvalue, Aₙ is the Eigen term, α is the ratio of the heat source radius to the base plate radius (r_{b}/rₐ), and α is the final heat diffusivity to be obtained; substituting the temperature and distance of the first measuring point R₁ and the second measuring point R₂ into the following equations (2) and (3) to calculate and obtain the M value (the ratio of thermal convection coefficient to conductivity) of the VC/thermal module/cold plate:
$$θ ( {R}_{1} , ∞ ) = \frac{{I}_{1} ( M ) {K}_{o} ( {MR}_{1} ) + {I}_{o} ( {MR}_{1} ) {K}_{1} ( M )}{M ( {I}_{1} ( M ) {K}_{1} ( aM ) - {I}_{1} ( aM ) {K}_{1} ( M ) )} ; \qquad ( 2 )$$
$$θ ( {R}_{2} , ∞ ) = \frac{{I}_{1} ( M ) {K}_{o} ( {MR}_{2} ) + {I}_{o} ( {MR}_{2} ) {K}_{1} ( M )}{M ( {I}_{1} ( M ) {K}_{1} ( aM ) - {I}_{1} ( aM ) {K}_{1} ( M ) )} ; \qquad ( 3 )$$
substituting the obtained distance between M and the first measuring point R₁ and the temperature T₁ at a certain transient moment t₁ into equation (1) to obtain the value of the heat diffusivity coefficient α, which is used to represent the transient heat diffusivity of the heat dissipation module.

2. The method for measuring the transient heat diffusivity of the heat dissipation module as claimed in claim 1, wherein through R=(X²+Y²)^{1/2}, equation (1) is transformed into the core calculation program of rectangular coordinates, and a three-dimensional diagram of the temperature distribution of rectangular coordinates is drawn as equation (6):
$$θ ( X , Y , τ ) = \frac{{I}_{1} ( M ) {K}_{0} ( {M ( {X}^{2} + {Y}^{2} )}^{1 / 2} ) + {I}_{0} ( {M ( {X}^{2} + {Y}^{2} )}^{1 / 2} ) {K}_{1} ( M )}{M ( {I}_{1} ( M ) {K}_{0} ( {( {X}_{1}^{2} + {Y}_{1}^{2} )}^{1 / 2} M ) - {I}_{1} ( M ) {K}_{1} ( {( {X}_{1}^{2} + {Y}_{1}^{2} )}^{1 / 2} M ) )} + {\sum }_{n = 1}^{∞} {A}_{n} [ {J}_{0} ( {{λ}_{n} ( {X}^{2} + {Y}^{2} )}^{1 / 2} ) {Y}_{1} ( {{λ}_{n} ( {X}_{1}^{2} + {Y}_{1}^{2} )}^{1 / 2} ) - {J}_{1} ( {λ}_{n} {( {X}_{1}^{2} + {Y}_{1}^{2} )}^{1 / 2} ) {Y}_{0} ( {{λ}_{n} ( {X}^{2} + {Y}^{2} )}^{1 / 2} ) ] {e}^{- ( {M}^{2} + {λ}_{n}^{2} ) τ} \qquad ( 6 )$$
$$θ ( X , Y , τ ) = \frac{T ( t ) - {T}_{∞}}{q / {k ( {X}^{2} + {Y}^{2} )}^{1 / 2}} ,$$
$$M = \sqrt{\frac{h}{k {t}_{b}}} {( {X}^{2} + {Y}^{2} )}^{1 / 2} ,$$
$$τ = \frac{α t}{{( {X}^{2} + {Y}^{2} )}^{1 / 2}} ,$$
$$α = \frac{τ ( {X}^{2} + {Y}^{2} )}{t}$$
in which: M is the ratio of thermal convection intensity to thermal conductivity, h is the convection heat transfer coefficient, K is the thermal conductivity, q is the input heat flux, X/Y is the dimensionless position of the base plate, X₁/Y₁ is the dimensionless location of the heat source, θ is the dimensionless temperature, T is the temperature (° C.), τ is the dimensionless time, t is the time (seconds), λₙ is the Eigenvalue, Aₙ is the Eigen term, and α is the final heat diffusivity to be obtained.
